(19) United States
(12) Patent Application Publication
(10) Pub. No.: US 2010/0175998 A1
(43) Pub. Date: Jul. 15, 2010

(54) Virtual channel platform

(76) Inventors: Shih-Kang Fan, Hsinchu (TW); Wen-Jung Chen, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/385,771

(22) Filed: Apr. 20, 2009

(30) Foreign Application Priority Data
Jan. 14, 2009 (TW) 98101187

(51) Int. Cl. G01N 27/453

(52) U.S. Cl. 204/600

(57) ABSTRACT

A virtual channel platform is disclosed. Said virtual channel platform comprises two electrode plates, which can provide an electric field, and two spacers set between said plates. Said plates are separated by said spacers for forming a passageway. A driven fluid is injected into said passageway. When applying electric signals of different frequencies in said plates, said plates form said electric field to drive said working fluid in a virtual channel.

### BACKGROUND OF THE INVENTION

1. Field of the Invention

The present invention relates generally to a platform for fluidic manipulations, more particularly, to a platform to controllably pump fluids in an electric-field-formed virtual channel without physical channel walls. Even more particularly, the present invention relates to a platform for fluid pumping and fluid formation by dielectrophoresis.

2. Description of Related Art

Pumping liquids in microchannels is essential to the study of microfluidics and practical to the wide applications including lab-on-a-chip (LOC) and micro total analysis systems (μTAS).

Various microfabrication techniques have been developed to carve and seal microchannels on silicon, glass, or polymer substrates. To drive liquids in microchannels, different pumping mechanisms have been investigated. For example, mechanical micropumps transport liquids through hydraulic pressure differences, while non-mechanical electroosmotic pumping relies on the zeta potential on the channel wall and electric potential difference across the liquid in a microchannel.

Although the microfabricated physical channel walls assist pumping in a mechanical or/and electrical way(s) as described above, they eliminate the controllability of the liquid streams during operation for different applications. In addition, the fabrication and sealing of the microchannels are usually complicated. The problems of liquid leakage and dead volume are commonly observed.

Hence, the inventors of the present invention believe that the shortcomings described above are able to be improved and finally suggest the present invention which is of a reasonable design and is an effective improvement based on deep research and thought.

### SUMMARY OF THE INVENTION

An object of the present invention is to provide a virtual channel platform which has no substantial flow channel and drives fluid based on an electric field. The platform is easy to manufacture.

Another object of the present invention is to provide a virtual channel platform flexibly controlling and delivering fluids without movable components (valves or pumps).

To achieve the above-mentioned objects, a virtual channel platform in accordance with the present invention is provided. The virtual channel platform includes two electrode plates for forming an electric field to drive fluids; and at least two spacers disposed between the two electrode plates so as to separate the two electrode plates for forming a planar fluidic passageway.

Advantageously, the two electrode plates consist of an upper electrode plate and a lower electrode plate. One electrode plate includes a substrate, where a conductive layer is coated as an electrode. A hydrophobic layer is coated on a surface of the electrode. The other electrode plate includes a substrate, where a plurality of conductive electrodes is disposed. A dielectric layer is coated on the electrodes and a hydrophobic layer is coated on the dielectric layer.

Advantageously, the planar passageway is further filled with a surrounding fluid to encompass the main driven fluid. A dielectric constant of the main driven fluid is greater than that of the surrounding fluid.

Advantageously, electric signals of different frequencies are applied to the electrodes of the electrode plates to generate an electric field in order to drive the main driven fluid in the planar passageway.

Advantageously, the electric field established by the two electrode plates generates a dielectrophoretic force in order to drive the main driven fluid of a higher dielectric constant along the strong electric field into the region of lower permittivity, i.e., the surrounding fluid, in the planar passageway.

Consequently, the virtual channel platform of the present invention has the merits as follows: the virtual channel platform of the present invention has a simple structure and has no movable component, and the virtual channel platform may be manufactured via a simple lithography process without complex channel structures and packaging; furthermore, the virtual channel platform of the present invention can drive the main pumped fluid by voltage applications at different frequencies to achieve programmable operation and control.

Additionally, the virtual channel platform of the present invention does not need an enclosed substantial flow channel, and doesn't need a movable component (valve or pump) to drive the main driven fluid.

To further understand features and technical contents of the present invention, please refer to the following detailed description and drawings related the present invention. However, the drawings are only to be used as references and explanations, not to limit the present invention.

### BRIEF DESCRIPTION OF THE DRAWINGS

FIG. 1A is a perspective view of a virtual channel platform of the present invention;

FIG. 1B is a cross-sectional view of the virtual channel platform of the present invention;

FIG. 2A is a schematic view of the virtual channel platform of the present invention, in operation state;

FIG. 2B is a schematic view of the virtual channel platform of the present invention, in another operation state;

FIG. 3A is a schematic view of a main driven fluid of the present invention; and

FIG. 3B is another schematic view of the main driven fluid of the present invention.

### DETAILED DESCRIPTION OF THE PREFERRED EMBODIMENTS

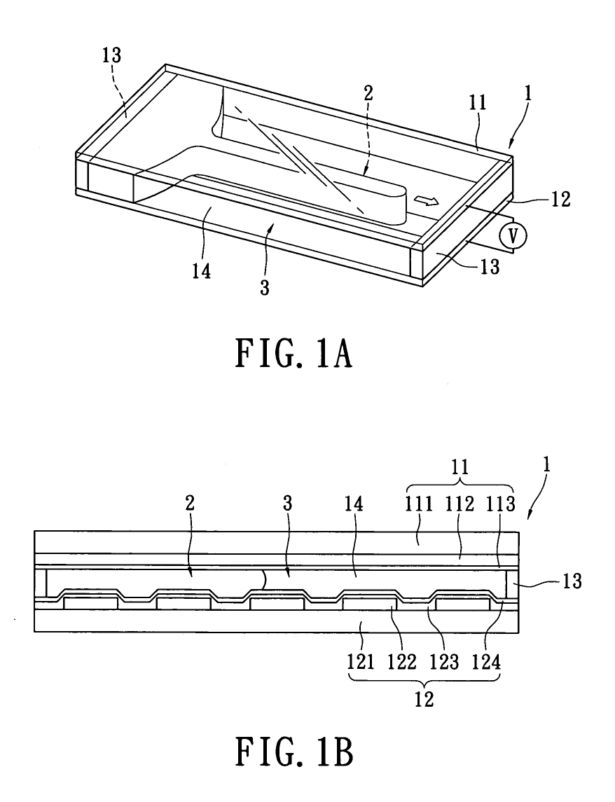

Please refer to FIG. 1A illustrating a virtual channel platform 1 according to the present invention, into which a main driven fluid 2 is injected. When the virtual channel platform 1 generates an electric field, the main driven fluid 2 located in the virtual channel platform 1 moves in the virtual channel platform 1 under the influence of the electric field. More specifically, the virtual channel platform 1 includes two electrode plates 11, 12 and at least two spacers 13. When a voltage is applied to the two electrode plates 11, 12, the two electrode plates 11, 12 will generate an electric field. The spacers 12 are disposed between the two electrode plates 11, 12.

Specifically, the two electrode plates 11, 12 are an upper electrode plate 11 and a lower electrode plate 12. Please refer to FIG. 1B, the upper electrode plate 11 further includes a substrate 111, a conductive layer 112 disposed on a surface of the substrate 111 and a hydrophobic layer 113 disposed on a surface of the conductive layer 112. The substrate 111 may be made of glass, silicon, poly-dimethylsiloxane (PDMS), polyethylene terephthalate (PET), polyethylene naphthalate (PEN), a flexible polymer, and so on. The conductive layer 112 and the hydrophobic layer 113 can be manufactured by semiconductor manufacturing technologies, e.g. thin film manufacturing technology. Furthermore, the conductive layer 112 may be made of metal, e.g., copper-chromium, oxide, Indium Tin Oxide (ITO), or conductive polymer. The conductive layer 112 can be deposited on the surface of the substrate 111 by physical vapor deposition including sputtering and evaporation. Furthermore, the material of the hydrophobic layer 113 can be Teflon coated on the surface of the conductive layer 112 by spin coating. Besides the spun Teflon, the hydrophobic layer 113 may also be manufactured by other materials and other processes, including chemical or physical vapor deposition, self-assembled formation of lipid surface monolayer and so on. It must be mentioned that the hydrophobic layer 113 is optionally disposed on the conductive layer 112 to facilitate handling of the main driven fluid 2 and produces a hydrophobic surface characteristic, thereby being convenient for driving the main driven fluid 2. The formation of the virtual channel and fluid pumping phenomenon may also occur on a virtual channel platform 1 without the hydrophobic layer 113. Additionally, if the main driven fluid 2 does not wet the surface of the conductive layer 112, the hydrophobic layer 113 may not necessary.

Further, it is worthy to mention that the material of the conductive layer 112 is not limited to copper-chromium metal or Indium Tin Oxide, and it may be any one of conductive metal materials, conductive polymer materials or conductive oxide materials.

The lower electrode plate 12 further includes a substrate 121, a plurality of conductive electrodes 122 disposed on a surface of the substrate 121, a dielectric layer disposed on the plurality of conductive electrodes 122 and a hydrophobic layer 124 disposed on a surface of the dielectric layer 123. The substrate 121 may be a substrate plate made of glass, silicon, poly-dimethylsiloxane (PDMS), polyethylene terephthalate (PET), polyethylene naphthalate (PEN), a flexible polymer, and so on. The plurality of conductive electrodes 122, the dielectric layer 123, and the hydrophobic layer 124 can be manufactured by semiconductor manufacturing technologies. Furthermore, the plurality of conductive electrodes 122 is not fixed in shape; they may be rectangle-shaped, straight-line-shaped, triangle-shaped, circular-shaped, or in any other shapes. The shape of the plurality of conductive electrodes 122 is determined based on user's demands. Also, the plurality of conductive electrodes 122 may be made of copper-chromium metal or Indium Tin Oxide (ITO), deposited by physical vapor deposition, including sputtering and evaporation. The material of the dielectric layer 123 may be parylene, a positive photoresist, a negative photoresist or a material with a high dielectric constant, or a material with a low dielectric constant, and the above material may be coated on the plurality of conductive electrodes 122 by spin coating, chemical or physical vapor deposition, sol-gel, or other thin film manufacturing technologies. It is worthy to mention that the dielectric layer 123 is optionally disposed on the lower electrode plate 12 according to the electric characteristic of the main driven fluid 2; that is, the dielectric layer 123 may be disposed on the lower electrode plate 12; or the dielectric layer 123 need not to be disposed on the lower electrode plate 12 since the electric characteristic of the main driven fluid 2 can meet the demands of the user. Furthermore, the material of the hydrophobic layer 124 is Teflon, and Teflon may also be coated on the surface of the conductive layer 112 by spin coating. Besides spin coating of Teflon, the hydrophobic layer 124 may also be manufactured by other materials with other processes, including chemical or physical vapor deposition, self-assembled monolayer, and so on.

It must be explained that the hydrophobic layer 124 is optionally disposed on the dielectric layer 123 to facilitate liquid handling of the main driven fluid 2. The formation of the virtual channel and fluid pumping phenomenon may also occur on a virtual channel platform 1 without the hydrophobic layer 124. Additionally, if the main driven fluid 2 does not wet the surface of the dielectric layer 123, the hydrophobic layer 124 may be not coated. Furthermore, if the dielectric layer 123 is not necessary for the electric characteristic of the main driven fluid 2 and the main driven fluid 2 does not wet the surface of the conductive layer 122, the hydrophobic layer 124 and the dielectric layer 123 may be not coated.

Furthermore, the material of the plurality of conductive electrodes 122 is not limited to copper-chromium metal or Indium Tin Oxide, and it may be any one of conductive metal materials, conductive polymer materials, or conductive oxide materials.

The at least two spacers 13 are disposed between the upper electrode plate 11 and the lower electrode plate 12. The at least two spacers 13 may be insulating gaskets so as to separate the upper electrode plate 1I1 from the lower electrode plate 12 for forming a planar passageway 14 into which the main drived fluid 2 is injected. A surrounding fluid 3 is also injected into the planar passageway 14 for encompassing the main driven fluid 2. It is worthy to be mentioned that the main driven fluid 2 and the surrounding fluid 3 are selected according to dielectric constants, as long as the dielectric constant of the main driven fluid 2 is greater than that of the surrounding fluid 3. So the main driven fluid 2 may be water and the surrounding fluid 3 may be air or silicone oil; alternatively, the main driven fluid 2 may be silicone oil and the surrounding fluid 3 may be air. More specifically, the main driven fluid 2 and the surrounding fluid 3 are not limited to the above descriptions, that is, the fluid of the two fluids selected by users having a higher dielectric constant is the main driven fluid 2, and the other fluid of the two selected fluids is the surrounding fluid 3.

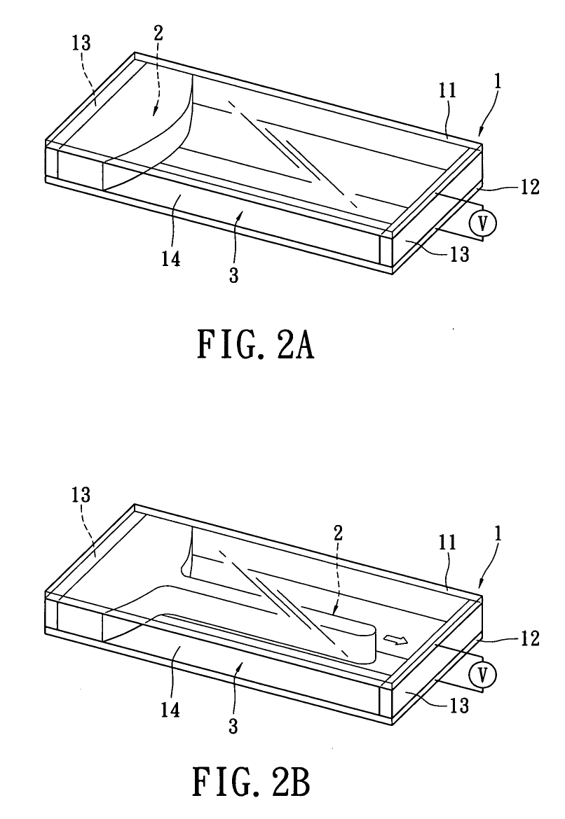

Please refer to FIGS. 2A-2B, when voltage of different frequencies is applied to the conductive layer 112 of the upper electrode plate 11 and the conductive electrodes 122 of the lower electrode plate 12 to generate an electric field, a force is generated between the interface of the main driven fluid 2 and the surrounding fluid 3 by dielectrophoresis. The force acts at the interface from the high dielectric constant main driven fluid 2 to the low dielectric constant surrounding fluid 3, so that the main driven fluid 2 moves along the electric field towards the surrounding fluid 3.

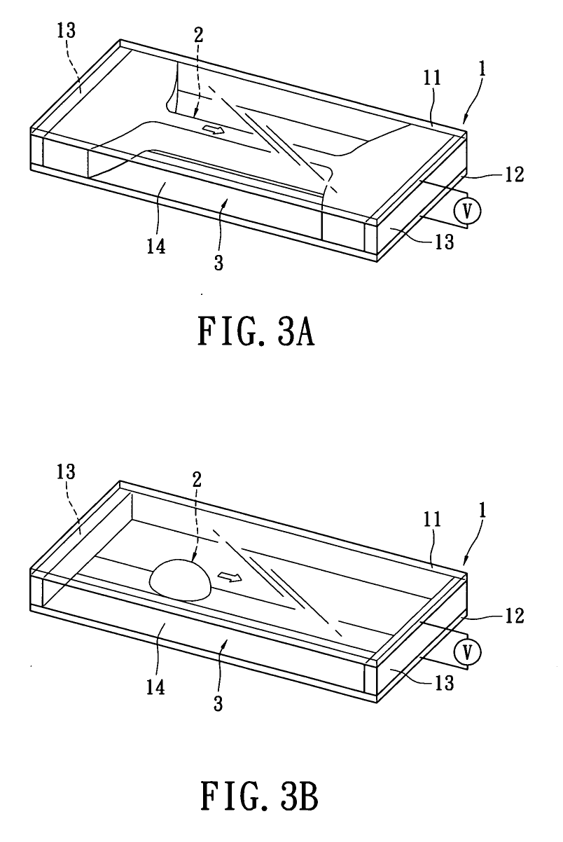

In detail, under the influence of the electric field, the main driven fluid 2 and the surrounding fluid 3 are electrically polarized in different degrees, so the molecules of the main driven fluid 2 and the surrounding fluid 3 tend to be aligned in the direction of the electric field. Further, if the electric field is spatially non-uniform generated by the shape of the patterned conductive electrodes 122 of the lower electrode plate 12, the electrically polarized main driven fluid 2 and surrounding fluid 3 under the influence of resultant (referred to as the dielectrophoretic force) generate drift movements in different degrees, thereby the main driven fluid 2 can move in the planar passageway 14 without a pump. Additionally, the main driven fluid 2 may move in the planar passageway 14 in the form of liquid columns (as shown in FIG. 3A) or liquid drops (as shown in FIG. 3B).

Consequently, the virtual channel platform of the present invention has the beneficial effects as follows:

1. The virtual channel platform 1 of the present invention has a simple structure, has no movable component and can be programmably operated and controlled.

2. The virtual channel platform 1 of the present invention may be manufactured via a simple semiconductor process (lithography process) and applies the voltage of different frequencies to the two electrode plates 11, 12 so as to generate an electric field in order to drive the main driven fluid 2, so that the main driven fluid 2 can move without a substantial flow channel and an outer pump.

3. The virtual channel platform 1 of the present invention does not need a close substantial flow channel, and instead of using a movable component (valve or pump) to drive the main driven fluid 2, the virtual channel platform 1 flexibly controls and projects the conveying path of the main driven fluid 2 based on the electric field.

4. The virtual channel platform 1 of the present invention can drive the main driven fluid 2 to move in the way of liquid columns (continuous way) or liquid drops (discontinuous way).

5. The virtual channel platform 1 of the present invention can save sample fluid and avoid waste.

What are disclosed above are only the specification and the drawings of the preferred embodiment of the present invention and it is therefore not intended that the present invention be limited to the particular embodiment disclosed. It will be understood by those skilled in the art that various equivalent changes may be made depending on the specification and the drawings of the present invention without departing from the scope of the present invention.

What is claimed is:

1. A virtual channel platform, comprising:
two electrode plates for forming an electric field; and
at least two spacers, disposed between the two electrode plates to separate the two electrode plates for forming a planar passageway into which a main driven fluid is injected, wherein the two electrode plates form the electric field so as to drive the main driven fluid in the planar passageway.

2. The virtual channel platform as claimed in claim 1, wherein the spacers are insulating gaskets.

3. The virtual channel platform as claimed in claim 1, wherein a surrounding fluid is further injected into the planar passageway to encompass the main driven fluid.

4. The virtual channel platform as claimed in claim 3, wherein a dielectric constant of the main driven fluid is greater than that of the surrounding fluid.

5. The virtual channel platform as claimed in claim 3, wherein the main driven fluid is water and the surrounding fluid is air.

6. The virtual channel platform as claimed in claim 3, wherein the main driven fluid is water and the surrounding fluid is silicone oil.

7. The virtual channel platform as claimed in claim 3, wherein the main driven fluid is silicone oil and the surrounding fluid is air.

8. The virtual channel platform as claimed in claim 1, wherein the two electrode plates consist of an upper electrode plate and a lower electrode plate.

9. The virtual channel platform as claimed in claim 8, wherein the upper electrode plate includes:
a substrate; and
a conductive layer, coated on a surface of the substrate.

10. The virtual channel platform as claimed in claim 9, wherein a material of the substrate is glass, silicon, poly-dimethylsiloxane, polyethylene terephthalate, polyethylene naphthalate, or a flexible polymer.

11. The virtual channel platform as claimed in claim 9, wherein a material of the conductive layer is copper-chromium metal, Indium Tin Oxide, a conductive metal material, a conductive polymer material, or a conductive oxide material.

12. The virtual channel platform as claimed in claim 9, further comprising a hydrophobic layer coated on a surface of the conductive layer.

13. The virtual channel platform as claimed in claim 12, wherein a material of the hydrophobic layer is Teflon or any material which can produce a hydrophobic surface characteristic.

14. The virtual channel platform as claimed in claim 12, wherein the conductive layer and the hydrophobic layer are manufactured by a thin film manufacturing technology.

15. The virtual channel platform as claimed in claim 8, wherein the lower electrode plate includes:
a substrate; and
a plurality of conductive electrodes, disposed on a surface of the substrate.

16. The virtual channel platform as claimed in claim 15, wherein the material of the substrate is glass, silicon, poly-dimethylsiloxane, polyethylene terephthalate, polyethylene naphthalate, or a flexible polymer.

17. The virtual channel platform as claimed in claim 15, further comprising a dielectric layer and a hydrophobic layer disposed on the lower electrode plate, wherein the dielectric layer is coated on the plurality of the conductive electrodes and the hydrophobic layer is coated on the dielectric layer.

18. The virtual channel platform as claimed in claim 17, wherein the plurality of the conductive electrodes, the dielectric layer, and the hydrophobic layer are manufactured by a thin film manufacturing technology.

19. The virtual channel platform as claimed in claim 15, wherein the shape of the plurality of conductive electrodes is rectangle-shaped, straight-line-shaped, triangle-shaped, circular-shaped, or in any other shapes.

20. The virtual channel platform as claimed in claim 15, wherein the material of the plurality of conductive electrodes is copper-chromium metal, Indium Tin Oxide, a conductive metal material, a conductive polymer materials, or a conductive oxide material.

21. The virtual channel platform as claimed in claim 17, wherein the material of the dielectric layer is parylene, a positive photoresist, a negative photoresist or a material with a high dielectric constant, or a material with a low dielectric constant.

22. The virtual channel platform as claimed in claim 17, wherein a material of the hydrophobic layer is Teflon or any material which can produce a hydrophobic surface characteristic.

23. The virtual channel platform as claimed in claim 15, wherein voltage of different frequencies is applied to the conductive electrodes of the lower electrode plate to generate an electric field so as to drive the main driven fluid in the planar passageway.

24. The virtual channel platform as claimed in claim 15, wherein the electric field generates a dielectrophoretic force so as to drive the main driven fluid in the planar passageway.
